(19) United States
(12) Patent Application Publication
(10) Pub. No.: US 2023/0391007 A1
(43) Pub. Date: Dec. 7, 2023

(54) HEATING TECHNIQUES FOR ADDITIVE MANUFACTURING

(71) Applicant: Materialise NV, Leuven (BE)

(72) Inventors: Frederik VAN DEN BRUEL, Leuven (BE); Brecht DAS, Leuven (BE)

(21) Appl. No.: 18/363,878

(22) Filed: Aug. 2, 2023

Related U.S. Application Data
(63) Continuation of application No. PCT/US2022/070296, filed on Jan. 21, 2022.
(60) Provisional application No. 63/144,684, filed on Feb. 2, 2021.

(51) Int. Cl. B29C 64/295; B29C 64/268; B29C 64/386

(52) U.S. Cl. CPC B29C 64/295; B29C 64/268; B29C 64/386; B33Y 10/00

(57) ABSTRACT

Certain aspects of the present disclosure generally relate to additive manufacturing, and more particularly, to methods and apparatus for heating during additive manufacturing. An example method that may be performed by an additive manufacturing apparatus generally includes dividing a heating area into a plurality of strips, the heating area defined in a layer of build material; randomly assigning indices to the plurality of strips; and applying energy by an energy source to the layer of build material across each of the plurality of strips in order of the randomly assigned indices.

### CROSS-REFERENCE TO RELATED APPLICATIONS

This application claims benefit of and priority to International Patent Application No. PCT/US2022/070296, filed Jan. 21, 2022, which claims benefit of and priority to U.S. Provisional Patent Application No. 63/144,684, filed Feb. 2, 2021, herein incorporated by reference in their entirety as if fully set forth below and for all applicable purposes.

### BACKGROUND

### Field of the Disclosure

This application relates to additive manufacturing. More particularly, this application relates to systems and methods for heating build material in a build area during additive manufacturing.

### Description of the Related Technology

In the field of additive manufacturing, three dimensional solid objects are formed from a digital model. Because the manufactured objects are three dimensional (“3D”), additive manufacturing is commonly referred to as 3D printing. Some example techniques for additive manufacturing include electron beam melting (“EBM”) or directed energy deposition. These techniques direct an electron beam or laser beam to a specified location in order to polymerize or solidify layers of build material, which are used to create a desired 3D object. The 3D object is built on a layer-by-layer basis by solidifying sequential layers of the build material.

Controlling the temperature of build material during different stages of additive manufacturing is important. For example, a pre-heating stage may be used to bring build material in a layer near its melting point prior to actually melting/sintering the build material in the layer as part of a melting stage. Gradually pre-heating build material, as opposed to trying to take build material from a cool state to a melted state quickly during a melting stage alone, may beneficially result in higher build quality and success rates.

Further, as another example, a post-heating stage may be used to control a rate of cooling of build material in a layer after melting/sintering has been performed for the layer. For example, instead of allowing the build material to cool on its own, a post-heating stage may be used to raise the temperature, or slow the rate of cooling of build material, which may help increase the quality of the object(s) built.

In certain cases, heating (e.g., pre-heating and/or post-heating) uses the electron or laser beam to heat the entire layer of build material and/or one or more portions or areas of the layer corresponding to one or more objects being built.

Accordingly, techniques for heating build material, including pre-heating and post-heating build material, are useful in additive manufacturing.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved systems and methods for heating a build material in a build area during additive manufacturing.

Certain embodiments provide a method for heating during additive manufacturing. The method generally includes dividing a heating area into a plurality of strips, the heating area defined in a layer of build material; randomly assigning indices to the plurality of strips; and applying energy by an energy source to the layer of build material across each of the plurality of strips in order of the randomly assigned indices.

Certain embodiments provide a user equipment (UE). The UE generally includes a memory; and a processor coupled to the memory, wherein the memory and the processor are configured to perform dividing a heating area into a plurality of strips, the heating area defined in a layer of build material; randomly assigning indices to the plurality of strips; and applying energy by an energy source to the layer of build material across each of the plurality of strips in order of the randomly assigned indices.

Certain embodiments provide a UE. The UE generally includes various means for performing the method of dividing a heating area into a plurality of strips, the heating area defined in a layer of build material; randomly assigning indices to the plurality of strips; and applying energy by an energy source to the layer of build material across each of the plurality of strips in order of the randomly assigned indices.

Certain embodiments provide a non-transitory computer-readable medium. The non-transitory computer-readable medium generally includes instructions that when executed by a user equipment (UE), cause the UE to perform the method of dividing a heating area into a plurality of strips, the heating area defined in a layer of build material; randomly assigning indices to the plurality of strips; and applying energy by an energy source to the layer of build material across each of the plurality of strips in order of the randomly assigned indices.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 is an example of a system for designing and manufacturing three-dimensional (“3D”) objects.

FIG. 2 illustrates a functional block diagram of one example of the computer shown in FIG. 1.

FIG. 3 shows a high-level process for manufacturing a 3D object.

FIG. 4A is an example of an additive manufacturing apparatus with a recoating mechanism.

FIG. 4B is a different example of an additive manufacturing apparatus with a recoating mechanism.

FIGS. 5A-5B show overhead views of a pre-heating pattern generated by a randomization process.

FIG. 6A-6D show overhead views of an additive manufacturing apparatus executing the pre-heating pattern from FIG. 5B.

FIGS. 7A-7B show an overhead view of different heating patterns overlaid on a build layer of an additive manufacturing apparatus.

FIGS. 8A-8D show an overhead view of different randomized heating patterns.

FIGS. 9A-9D show an overhead view of different heating patterns overlaid on different build parts.

FIG. 10 depicts an example method for generating a randomized heating pattern.

FIG. 11 depicts an example method for implementing a randomized heating pattern on an additive manufacturing apparatus.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer readable mediums for heating build material in a build area during additive manufacturing. For example, aspects discussed herein may be used for pre-heating and/or post-heating of build material. Certain aspects are discussed herein with respect to particular types of additive manufacturing, such as electron beam melting (“EBM”). However, it should be noted that the techniques discussed herein may also be applicable to other types of additive manufacturing and are not limited solely to EBM. For example, other heating devices, such as a laser, may be used instead of an electron beam to apply energy to build material to heat the build material.

EBM uses an electron beam to heat the build material, which poses a few challenges. For example, when using an electron beam it is important to limit the amount of electromagnetic charge introduced in a given area of the build material. If there is a buildup of electromagnetic charge, the resulting material properties of the build material may be adversely affected or a discharge can occur that will “explode” or vaporize the build material, causing a failure of the build.

Accordingly, certain aspects relate to techniques where energy, such as from an electron beam, is applied to the build material in a manner that heats the build material while avoiding an excess buildup of electromagnetic charge. Thus, the techniques herein provide an improvement to the technology of additive manufacturing by helping avoid build failures.

Certain techniques for pre-heating using an electron beam are discussed in European Patent Application Number 06758093.6, filed on Jul. 27, 2006, which is hereby incorporated by reference. The techniques described in 06758093.6 require calculation and maintenance of a “minimum security distance” between consecutively scanned paths used for pre-heating.

The techniques discussed herein differ from those discussed in 06758093.6. In certain aspects, the techniques herein relate to a randomly-generated ordering of scan paths to use for heating (e.g., pre-heating and/or post-heating) of build material in additive manufacturing. In certain aspects, such techniques help to reduce or eliminate the possibility of buildup of electromagnetic charge in build material during heating, thereby avoiding issues with poor build or failed build as discussed. Accordingly, such techniques help improve the field of additive manufacturing. Further, such techniques avoid the need for the maintenance of a minimum security distance between consecutively scanned paths.

Additive manufacturing processes generally include providing energy from an energy source (e.g., a laser or an electron beam) to solidify (e.g., polymerize) layers of build material (e.g., polymer or metal). For example, an additive manufacturing machine may selectively apply energy from an energy source to the layer of build material based on processing parameters indicated in a job file. The job file may include information regarding slices of a digital representation of an object or objects to be built using the additive manufacturing machine. For example, three dimensional (“3D”) objects represented by computer-aided design (“CAD”) files may be arranged in a virtual build area corresponding to the build area of the additive manufacturing machine. The resulting 3D objects may be divided into layers or slices, as discussed. The job file, accordingly, may include slices (e.g., a stack of slices) of the 3D objects, and processing parameters of the additive manufacturing machine for building the 3D objects. It should be noted that as discussed herein, the terms slice and layer may be used interchangeably.

For example, for each slice, the job file may include processing parameters corresponding to a pre-heating stage, a melting stage, and/or post-heating stage for building one or more objects. The processing parameters may include one or more of energy level/power used for scanning, scan direction, scan speed, etc. In certain aspects, the processing parameters include one or more patterns indicating a path (e.g., toolpath) over which the additive manufacturing device applies energy to (e.g., electron beam to pre-heat, electron beam to melt, and/or electron beam to post-heat) the physical layer of build material corresponding to that slice. For example, the one or more patterns may include one or more of a pre-heating pattern, a melting pattern, and/or a post-heating pattern. Each “pattern” may refer to a set of vectors over which the additive manufacturing device scans the energy source on the build material.

Pre-heating patterns are used for pre-heating during the pre-heating stage, which is a process that elevates the temperature of at least a portion of the layer of build material below (e.g., near) its melting point prior to melting the layer. Pre-heating can reduce the amount of energy needed at the melting stage to melt (e.g., solidify) the layer of build material. Further, pre-heating patterns discussed herein may help limit the amount of energy (e.g., electromagnetic charge) accumulated at a time in the layer of the build material while manufacturing one or more objects.

Melting patterns are used for melting during the melting stage, which is after the pre-heating stage. Melting is the process of solidifying layers of the build material to form the 3D object.

Post-heating patterns are used for post-heating during the post-heating stage, which is after the melting stage. Post-heating patterns may be used to control a rate of cooling of one or more portions of the layer of build material by applying energy to the build material to slow the rate of cooling.

The one or more patterns may each include one or more vectors such that each vector indicates a spatial position for the energy source to apply the energy to the layer of build material (e.g., a starting point) and a direction for the energy source to apply the energy to the build material (e.g., a direction to move the laser beam, electron beam, or other energy source over the build material while printing). In certain aspects, the pre-heating, melting, and/or post-heating patterns may be different from one another. Aspects of heating patterns including pre-heating and/or post-heating patterns that use randomly generated scan paths (e.g., corresponding to vectors) are described in further detail herein with respect to the figures.

Though some embodiments described herein are described with respect to certain additive manufacturing techniques using certain build materials, the described systems and methods may also be used with certain other additive manufacturing techniques and/or certain other build materials as would be understood by one of skill in the art.

### Examples of Systems and Processes for Manufacturing 3D Objects

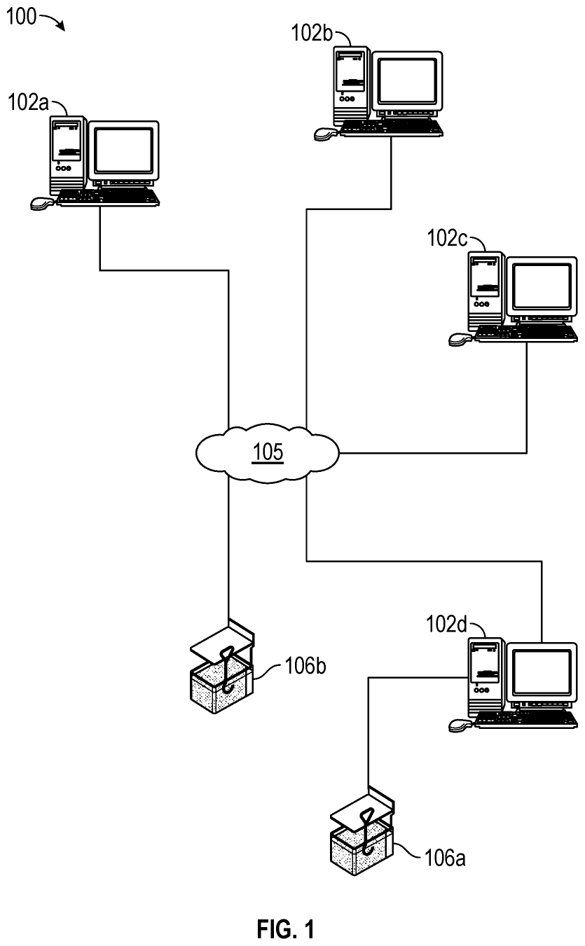

Embodiments of heating techniques may be practiced within a system for designing, simulating, and/or manufacturing 3D objects. Turning to FIG. 1, an example of a computer environment suitable for the implementation of 3D object design, build simulation, and manufacturing is shown. The environment includes a system 100. The system 100 includes one or more computers 102a-102d, which can be, for example, any workstation, server, or other computing device capable of processing information. In some embodiments, each of the computers 102a-102d can be connected, by any suitable communications technology (e.g., an internet protocol), to a network 105 (e.g., the Internet). Accordingly, the computers 102a-102d may transmit and receive information (e.g., software, digital representations of 3D objects, commands or instructions to operate an additive manufacturing machine, etc.) between each other via the network 105.

The system 100 further includes one or more additive manufacturing machines (e.g., 3D printers) 106a-106b. As shown the additive manufacturing machine 106a is directly connected to a computer 102d (and through computer 102d connected to computers 102a-102c via the network 105) and additive manufacturing machine 106b is connected to the computers 102a-102d via the network 105. Accordingly, one of skill in the art will understand that an additive manufacturing machine 106 may be directly connected to a computer 102, connected to a computer 102 via a network 105, and/or connected to a computer 102 via another computer 102 and the network 105.

It should be noted that though the system 100 is described with respect to a network and one or more computers, the techniques described herein also apply to a single computer 102, which may be directly connected to an additive manufacturing machine 106.

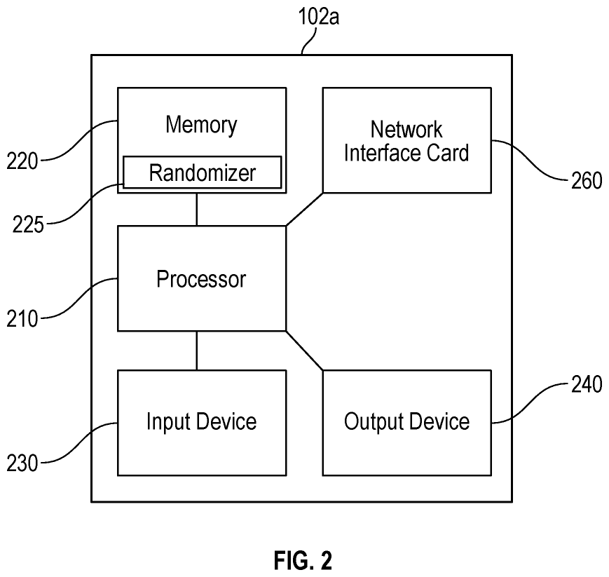

FIG. 2 illustrates a functional block diagram of one example of a computer of FIG. 1. The computer 102a includes a processor 210 in data communication with a memory 220, an input device 230, and an output device 240. Though not shown, other computers (e.g., 102b-102d in FIG. 1) may have similar components as shown for computer 102a. In some embodiments, the processor is further in data communication with an optional network interface card 260. Although described separately, it is to be appreciated that functional blocks described with respect to the computer 102a need not be separate structural elements. For example, the processor 210 and memory 220 may be embodied in a single chip.

The processor 210 can be a general purpose processor, a digital signal processor (“DSP”), an application specific integrated circuit (“ASIC”), a field programmable gate array (“FPGA”) or other programmable logic device, discrete gate or transistor logic, discrete hardware components, or any suitable combination thereof designed to perform the functions described herein. A processor may also be implemented as a combination of computing devices, e.g., a combination of a DSP and a microprocessor, a plurality of microprocessors, one or more microprocessors in conjunction with a DSP core, or any other such configuration.

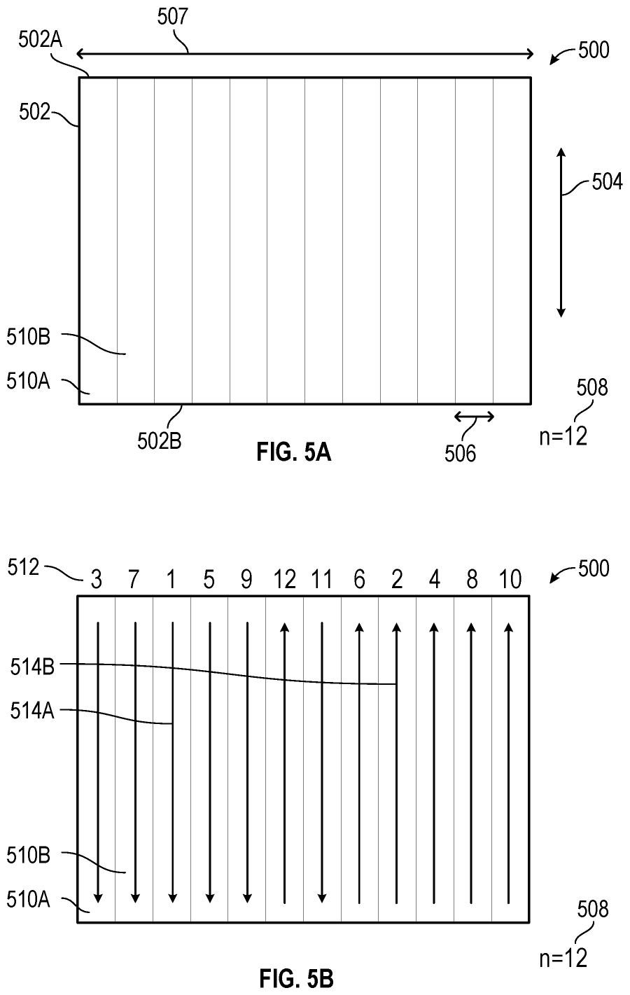

The processor 210 can be coupled, via one or more buses, to read information from or write information to memory 220. The processor may additionally, or in the alternative, contain memory, such as processor registers. The memory 220 can include processor cache, including a multi-level hierarchical cache in which different levels have different capacities and access speeds. The memory 220 can also include random access memory (RAM), other volatile storage devices, or non-volatile storage devices. The storage can include hard drives, flash memory, etc. Memory 220 can also include a randomizer 225 which is used to generate random numbers as described in FIG. 5B. Randomizer 225 may be code that can be executed by processor 210. In various instances, the memory may be referred to as a computer-readable storage medium. The computer-readable storage medium is a non-transitory device capable of storing information, and is distinguishable from computer-readable transmission media such as electronic transitory signals capable of carrying information from one location to another. Computer-readable medium as described herein may generally refer to a computer-readable storage medium or computer-readable transmission medium.

The processor 210 also may be coupled to an input device 230 and an output device 240 for, respectively, receiving input from and providing output to a user of the computer 102a. Suitable input devices include, but are not limited to, a keyboard, buttons, keys, switches, a pointing device, a mouse, a joystick, a remote control, an infrared detector, a bar code reader, a scanner, a video camera (possibly coupled with video processing software to, e.g., detect hand gestures or facial gestures), a motion detector, or a microphone (possibly coupled to audio processing software to, e.g., detect voice commands). Suitable output devices include, but are not limited to, visual output devices, including displays and printers, audio output devices, including speakers, headphones, earphones, and alarms, additive manufacturing machines, and haptic output devices.

The processor 210 further may be coupled to a network interface card 260. The network interface card 260 prepares data generated by the processor 210 for transmission via a network according to one or more data transmission protocols. The network interface card 260 also decodes data received via a network according to one or more data transmission protocols. The network interface card 260 can include a transmitter, receiver, or both. In other embodiments, the transmitter and receiver can be two separate components. The network interface card 260, can be embodied as a general purpose processor, a DSP, an ASIC, a FPGA or other programmable logic device, discrete gate or transistor logic, discrete hardware components, or any suitable combination thereof designed to perform the functions described herein.

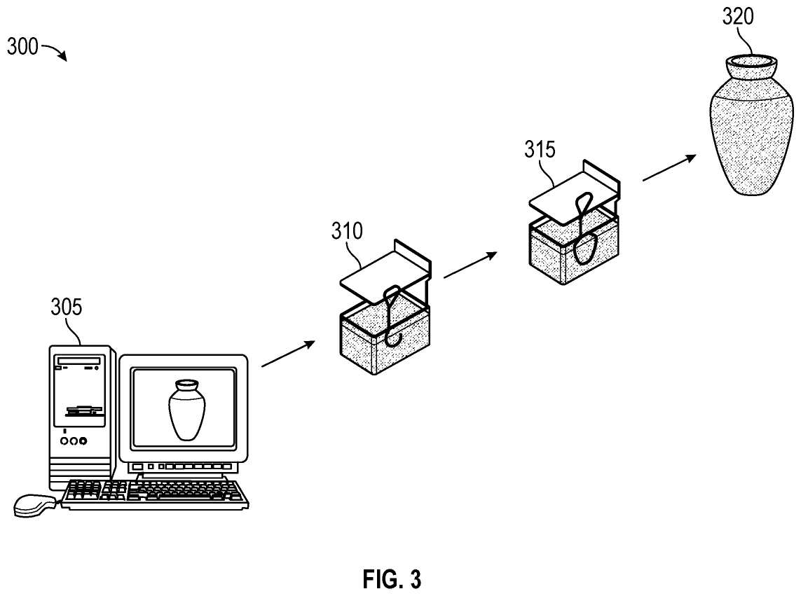

FIG. 3 illustrates a process 300 for manufacturing a 3D object or device. As shown, at a step 305, a digital representation of the object is designed using a computer (e.g., computer 102a from FIG. 1). For example, two dimensional (“2D”) or 3D data may be input to the computer for aiding in designing the digital representation of the 3D object. Continuing at a step 310, information corresponding to the 3D object is sent from the computer to an additive manufacturing machine (e.g., additive manufacturing machine 106 from FIG. 1), and the machine commences a manufacturing process for generating the 3D object in accordance with the received information. At a step 315, the additive manufacturing machine continues manufacturing the 3D object using suitable materials, such as a polymer or metal powder. Further, at a step 320, the 3D object is generated.

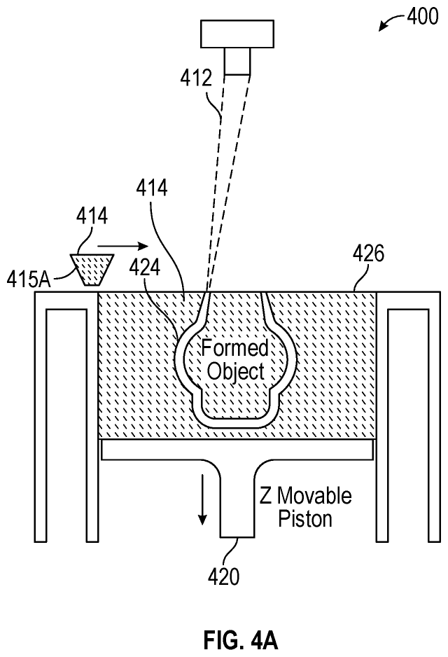

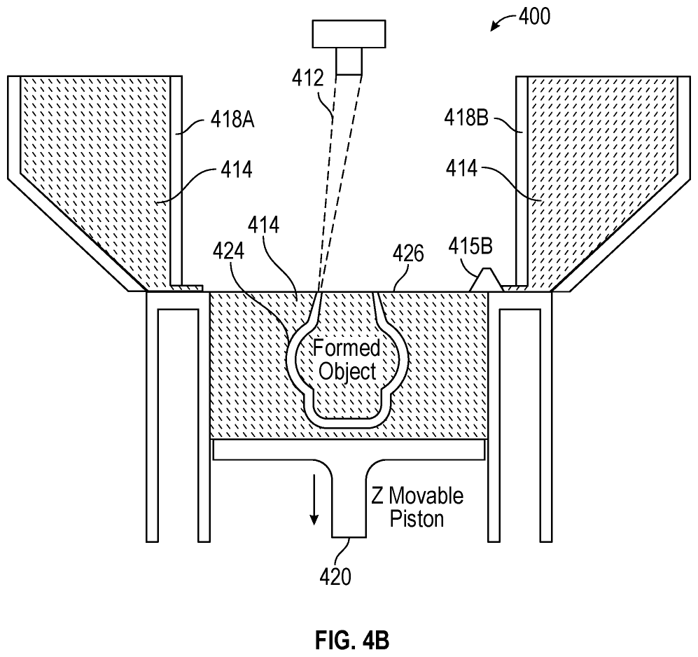

FIG. 4A illustrates an example additive manufacturing apparatus 400 for generating a 3D object. In this example, the additive manufacturing apparatus 400 is an EBM machine. EBM machine 400 may be used to generate one or more 3D objects layer by layer. EBM machine 400, for example, may utilize a powder (e.g., metal), such as a powder 414, as a build material to build an object 424 a layer at a time as part of a build process.

Successive layers of build material (e.g., build layers), such as powder layers, are spread on top of each other using, for example, a recoating mechanism 415A (e.g., a re-coater blade). The recoating mechanism 415A deposits powder as a layer as it moves across a build area 426, for example in the direction shown, or in the opposite direction if the recoating mechanism 415A is starting from the other side of build area 426, such as for another layer of the build. The build area may be the entire area over which powder is deposited and that can be scanned by electron beam 412. In certain embodiments, after deposition, during a pre-heating stage, a computer-controlled electron beam 412 scans the surface and pre-heats one or more portions of the powder layer according to one or more pre-heating patterns. Further, electron beam 412 selectively binds together the powder particles of the corresponding cross-section of object 424 during a melting stage (e.g., after a pre-heating stage). During electron beam exposure in the melting stage, the powder temperature rises above the material (e.g., metal) transition point after which adjacent particles flow together (e.g., bind) to create 3D object 424. In certain embodiments, after binding, electron beam 412 scans the surface and post-heats one or more portions of the powder layer according to one or more post-heating patterns during a post-heating stage.

Once the build for a layer is complete (e.g., after the melting stage or a post-heating stage), a depth of build area 426 is controlled by a moveable piston 420, which increases the depth of build area 426 via downward movement as additional powder is deposited by recoating mechanism 415A into build area 426. Thus, build area 426 holds formed object 424 as object 424 is built. The layering process is then repeated until the build process is complete and 3D object 424 is formed.

In other embodiments, such as shown with respect to FIG. 4B, at least one hopper (e.g., a first hopper 418A and/or a second hopper 418B) and a powder layering system 415B (e.g., a rake) may be used instead of the recoating mechanism (e.g., recoating mechanism 415A in FIG. 4A). Accordingly, the powder 414 may be distributed using hoppers 418A and 418B that flow powder 414 onto build area 426. The depth of build area 426, in turn, is controlled by moveable piston 420, which increases the depth of build area 426 via downward movement as additional powder is moved from the powder hoppers 418A and 418B into build area 426. Powder layering system 415B distributes (e.g., pushes and/or rolls) powder 414 from powder hoppers 418A and 418B into build area 426.

The operations described in FIGS. 4A and 4B take place in a chamber and under vacuum to ensure a clean and controlled environment. Additionally, an external or integrated heater may be used as part of the chamber to raise the temperature of powder 414 independently of electron beam 412, which beneficially reduces the energy required by election beam 412 for pre-heating, melting, and/or post-heating. Similarly, a separate heater or heaters may be used to pre-heat the powder inside hoppers 418A and 418B.

### Example Techniques for Generating Randomized Heating Patterns

FIGS. 5A and 5B show overhead views of a heating pattern (e.g., pre-heating and/or post-heating) generated by a randomization process. The overhead views may correspond to the plane across the build area, such as parallel with a build plate.

In particular, FIG. 5A shows a heating area 500 segmented into strips 510 (e.g., a first strip 510A and a second strip 510B). It is noted that although heating area 500 is shown as a rectangle, other areas may be used such as a circle, polygon or other freeform shape. Further, in certain embodiments, a different heating area 500 may be defined for different layers. In certain embodiments, a boundary 502 of a heating area 500 is determined or defined, or may be preset. As shown, boundary 502 includes an upper boundary 502A and a lower boundary 502B. In some embodiments, a size and/or shape of boundary 502 corresponds to one or more features, such as the build area, a cross-section of one or more objects within the layer, etc. For example, in certain embodiments, the size and shape of boundary 502 is the size and shape of a perimeter of the entire build area (e.g., corresponding to the build plate). In certain embodiments, a shape of boundary 502 is the same as the shape of the entire build area and the size of boundary 502 reduced in size (e.g., by a distance/threshold) from the perimeter of the entire build area. In certain embodiments, the size and shape of boundary 502 is the size and shape of a cross-section of an object within the layer. In certain embodiments, the shape of boundary 502 is the same as the shape of a cross-section of an object within the layer and the size of boundary 502 reduced or increased in size (e.g., by a distance/threshold) from the perimeter of the cross-section of the object within the layer.

In some embodiments, boundary 502 is assigned by a user. In some embodiments, boundary 502 is automatically generated by a processor (e.g., processor 210 in FIG. 2), such as based on the build area and/or a cross-section of one or more objects within the layer. In certain embodiments, heating area 500 is segmented into parallel strips 510 where each strip corresponds to a heating vector as further discussed in FIG. 5B.

A longitudinal direction 504 of strips 510 may be set by the user, set as a constant, or determined automatically. Longitudinal direction 504 is a direction parallel to a length of strips 510 (e.g., as opposed to a width of strips 506). The direction of the heating vectors is parallel to longitudinal direction 504.

Width of strips 506 (e.g., strip width) may be set by a user, set as a constant, or determined automatically. For example, strip width 506 may be determined based on the additive manufacturing machine, the machine settings, or the heating vectors. In one embodiment using an EBM machine, the width may be dependent on the power settings for an electron beam such that a higher power or energy beam results in a wider strip. A total number of strips 508 (e.g., strip number) is calculated by dividing a width 507 of the heating area 500 by strip width 506. In this embodiment, strip width 506 is a constant for all strips 510. In other embodiments, strip width may vary such that the strips are not all the same width.

FIG. 5B shows a process for assigning indices 512 to strips 510 and heating vectors 514 (e.g., a first heating vector 514A and a second heating vector 514B). As previously discussed, strips 510 correspond to heating vectors 514. Each heating vector 514 indicates a spatial position (e.g., a starting point) for the energy source (e.g., electron beam or laser beam) to apply energy to the build layer and a direction for the energy source to apply the energy to the build layer (e.g., a direction and/or path to scan the laser beam, electron beam, or other energy source over the build layer while heating). Thus, a heating pattern includes heating vectors and provides a path (e.g., toolpath) over which the energy source applies energy to the build layer.

Once strips 510 are defined and the number of strips 508 is determined, a randomizer (e.g., randomizer 225 in FIG. 2) is used to randomly assign indices 512 to strips 510. In this embodiment, the randomizer operates such that it uses an array of integers (e.g., from 1 to strip number 508) from which to randomly select an integer and assigns the selected integer as the index for a strip (e.g., first strip 510A). Once the integer is assigned, the selected integer is removed from the array and the randomizer repeats the process for selection of an integer as the index for a next (e.g., adjacent) strip. In this embodiment, the array of integers start with 1 and end at strip number 508 (e.g., 12). When assigning indices 512, the randomizer starts with first strip 510A and assigns it a random number (e.g., 3) from the array of integers as its index. The randomizer continues to second strip 510B and assigns it a random number (e.g., 7) from the updated array of integers as its index, where the updated array does not contain the integer assigned to first strip 510A (e.g., 3). The indices 512 may be assigned to strips 510 in the order of their position, such as starting from one end of heating area 500 to the other end of heating area 500 along width 507. The assignment process for indices 512 continues until all strips 510 are assigned an index. It should be noted that the randomizer used may vary. In some embodiments, a random number generator is used. In some embodiments, a numpy.random.rand function is used corresponding to the NumPy library from Python.

In some embodiments, the array of integers start at 0 and end at strip number less one (e.g., 11). In some embodiments, other methods of assigning indices may be used such as an array that does not rely on the strip number or an array that includes non-integers, even-only or odd-only integers, or letters.

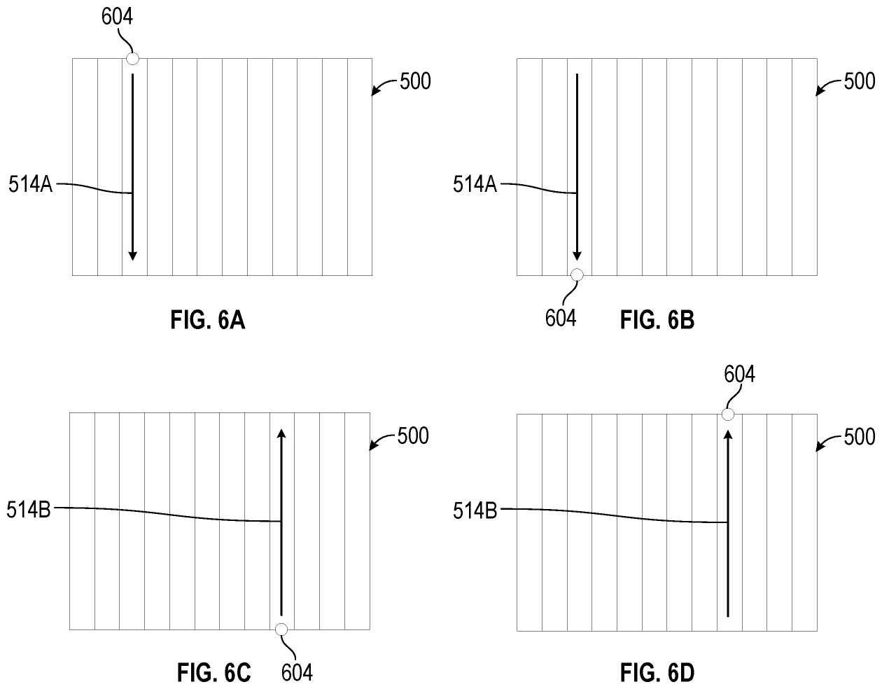

Thus, indices 512 provide an order for the energy source to scan the heating vectors 514 when heating one or more portions of the build layer. In this embodiment, the energy source scans the heating vector corresponding to index 1 (e.g., first heating vector 514A) first, then the energy source scans the heating vector corresponding to index 2 (e.g., second heating vector 514B) second, and so forth, until the energy source scans all heating vectors in the heating pattern. As previously discussed, heating vectors include the position and the direction for the energy source to follow. For example, the energy source starts at a first end of heating vector 514A and scans to a second end of heating vector 514A. In this embodiment, the direction of the heating vectors alternates such that first heating vector 514A scans from a first side of the boundary (e.g., upper boundary 502A in FIG. 5A) to a second side of the boundary (e.g., lower boundary 502B in FIG. second heating vector 514B scans from a second side of the boundary to the first side and so forth. This is discussed further in FIGS. 6A-6D. In some embodiments, the direction of heating vectors does not alternate. In some embodiments, the direction of strips and heating vectors is randomized.

In certain embodiments, heating patterns may include additional information. For example, in certain embodiments, a magnitude of energy may be assigned to heating vectors 514. In some embodiments, different magnitudes of energy may be assigned to different heating vectors 514 such that the magnitude may vary with each heating vector (e.g., first heating vector 514A and second heating vector 514B). This may beneficially allow precise control of the energy or heat inputted into a given area of the build material. In some embodiments, the magnitude of the energy may vary with the position of an individual heating vector (e.g., first heating vector 514A). For example, additional energy or heat may be applied in areas of the build layer localized to the cross-section of the object being formed. In some cases, varying the magnitude of energy results in a more efficient build process and better material properties for the resulting object. In certain embodiments, heating patterns may also assign a speed at which to scan the vector. The speed may be varied in a manner similar to the magnitude of energy and result in similar benefits.

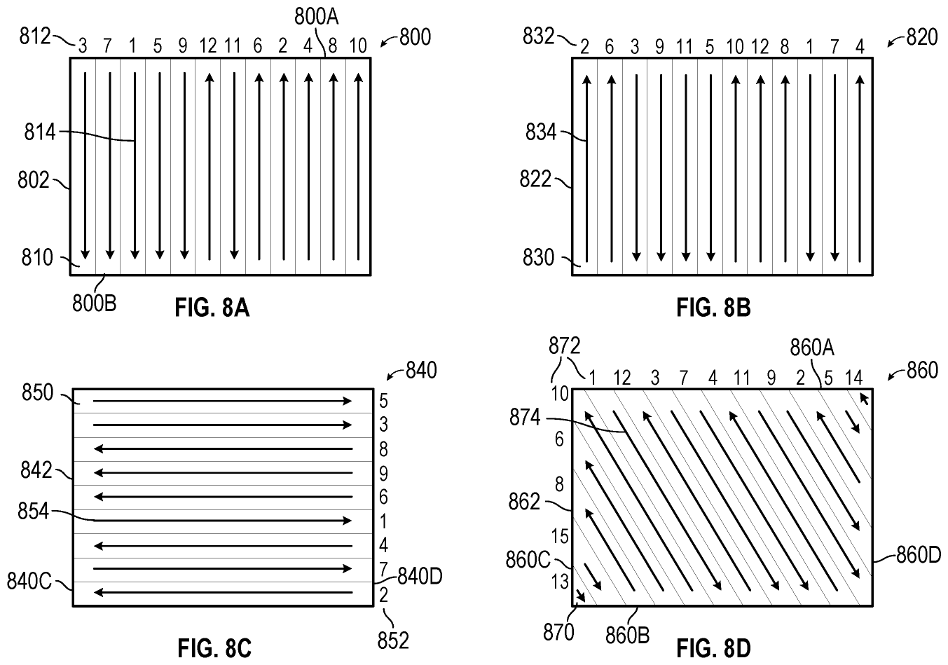

In the embodiments depicted in FIGS. 5A and 5B, strips 510 are shown with longitudinal direction 504 perpendicular to the upper and lower boundaries 502A and 502B of heating area 500. In other embodiments, the strips may not be perpendicular to the upper and lower boundaries and may be in another orientation such as parallel or angled such as in FIGS. 8C and 8D.

### Example Implementations of Randomized Heating Patterns

FIGS. 6A-6D show overhead views of an additive manufacturing machine scanning heating vectors 514 of the heating pattern from FIG. 5B. In particular, FIGS. 6A-6D show how an energy source 604 scans heating vectors 514 according to the indices assigned

FIG. 6A shows energy source 604 in a first position, before it scans first heating vector 514A. FIG. 6B shows energy source 604 in a second position, after it scans first heating vector 514A. FIG. 6C shows energy source 604 in a third position, before it scans second heating vector 514B. FIG. 6D shows energy source 604 in a fourth position, after it scans second heating vector 514B. The energy source continues to scan according to the heating pattern until all the heating vectors (e.g., heating vectors 514 in FIG. 5B) are scanned.

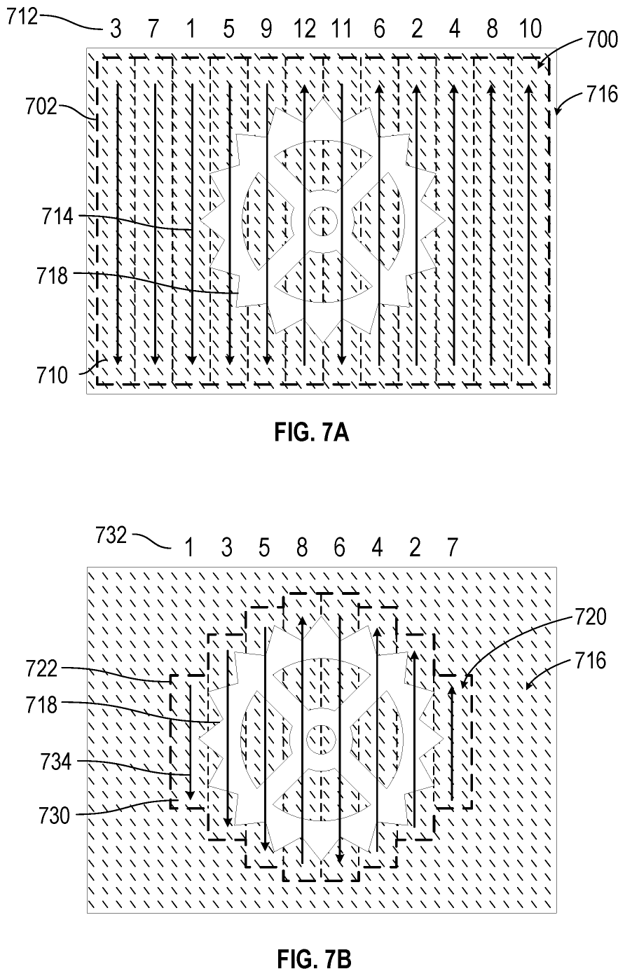

FIGS. 7A and 7B show an overhead view of different heating patterns overlaid on a build layer 716 of an additive manufacturing machine. Heating patterns can be formed across the entire build layer or only a portion of the build layer. In some embodiments, the heating pattern covers areas that correspond to the cross-section of the object being formed (e.g., a build part 718). In some embodiments, the heating pattern covers areas that correspond to other portions of the build layer.

In particular, FIG. 7A shows a heating pattern similar to the heating pattern in FIG. 5B and includes a heating area 700, a boundary 702, strips 710, indices 712, and heating vectors 714. In this embodiment, the shape of boundary 702 is the same as the shape of a build area (e.g., corresponding to build layer 716) and the size of boundary 502 is reduced in size by a distance from the perimeter of the entire build area. Thus, heating area 700 is less than the area of build layer 716 and boundary 702 is smaller than the boundary of build layer 716. As previously discussed, the build area includes the build material (e.g., metal powder) that makes up build layer 716. Boundary 702 and strips 710 are shown as dashed lines to emphasize they are illustrative concepts and not physically present on build layer 716. A cross-section of build part 718 (e.g., 3D object 424 in FIG. 4A) is contained within both build layer 716 and heating area 700. Build part 718 is a 3D object created by an additive manufacturing machine, from the build material, using the heating patterns and cross-sections of the object being formed.

FIG. 7B shows a localized heating pattern for a localized heating area 720 which has a localized boundary 722. The heating pattern is localized because it conforms to the areas of build layer 716 localized to the cross-section of build part 718. Thus, the size of localized boundary 722 is increased in size by a distance from a perimeter of the cross-section of build part 718 such that localized boundary 722 encases build part 718. Localized heating area 720 is smaller than the area of build layer 716 and the area of the previous heating area (e.g., heating area 700 in FIG. 7A). Localized heating area 720 includes localized strips 730 and localized indices 732, which are randomly assigned to localized strips 730 in a process similar to the one previously discussed. Localized heating vectors 734 are then generated and assigned localized indices 732 as previously discussed.

FIGS. 8A-8D show overhead views of different randomized heating patterns. In particular, FIGS. 8A-8D show different heating vectors for each randomized heating pattern.

FIG. 8A shows a heating pattern including a heating area 800, a boundary 802, strips 810, indices 812, and heating vectors 814 similar to FIG. 5B. In this embodiment, strips run from a first side 800A of area 800 and end at a second side 800B of area 800.

FIG. 8B shows a heating pattern including a heating area 820, a boundary 822, strips 830, indices 832, and heating vectors 834 similar to, but different from, FIG. 8A. In this embodiment, indices 832 are randomly generated and thus are different than indices 812, even though strips 830 are the same strip width, orientation, and strip number as those in FIG. 8A.

FIG. 8C shows a heating pattern including a heating area 840, a boundary 842, strips 850, indices 852, and heating vectors 854. In this embodiment, heating area 840 is broken into strips 850 which are oriented perpendicular to that of the strips of FIG. 8A (e.g., strips 810) such that strips 850 run from a third side 840C of area 840 and end at a fourth side 840D of area 840.

FIG. 8D shows a heating pattern including a heating area 860, a boundary 862, strips 870, indices 872, and heating vectors 874. In this embodiment, heating area 860 is broken into strips 870 which are oriented diagonally such that the strips run from a first side 860A and third side 860C of area 860 and end at a second side 860B and fourth side 860D of area 860.

In some embodiments, a heating pattern may be used multiple times per a build layer. For example, a build layer may be heated by repeatedly scanning heating vectors of FIG. 8B until the desired level of heating for the build layer is achieved. This beneficially increases the temperature of the build layer in a consistent manner. In some embodiments, multiple heating patterns can be used per each build layer. For example, the build layer may be heated using different heating patterns such as by alternating between scanning the heating vectors of FIG. 8A and FIG. 8C. This beneficially increases the temperature of the build layer in a more random manner and prevents buildup of heat in certain locations. Thus, the heating patterns in FIGS. 8A-8D may be used individually or in any combination with each other per a given build layer.

In some embodiments, different portions of each build layer can use the same heating pattern or different heating patterns such that at least one of the heating patterns does not form across the entire build layer. Heating patterns used for different portions of the build layer may or may not overlap. For example, a build layer may be heated by scanning the heating vectors of FIG. 8A on its left side and scanning the heating vectors of FIG. 8C on its right side such that there is no overlap between the two heating patterns. In a different but similar example, the heating patterns of FIGS. 8A and 8C may overlap in the middle of the build layer.

In some embodiments, a given portion of a build layer can use the same heating pattern or different heating patterns. For example, the heating vectors of FIG. 8B can be scanned once or repeatedly on the given portion of the build layer. Similarly, the given portion of the build layer may be heated using different heating patterns such as by alternating between scanning the heating vectors of FIGS. 8A and 8C.

Although a few embodiments were presented, one skilled in the art would understand that in other embodiments the strips may start and end at other sides of the heating area, may vary in width, and may be oriented in patterns or angles not shown.

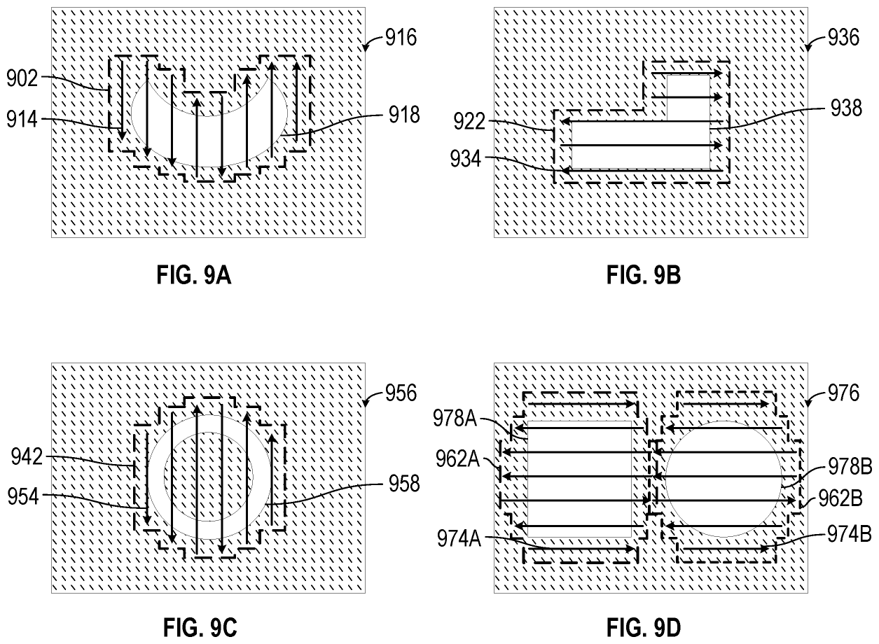

FIG. 9A-9D show an overhead view of different heating patterns overlaid on different build parts. In particular, FIGS. 9A-9D show how heating patterns can conform to and vary with different build part geometries. For clarity, the boundaries of the strips of the heating patterns are not shown.

FIG. 9A shows a build layer 916 for a first build part 918 where the heating pattern includes a boundary 902 and heating vectors 914. Heating vectors 914 extend past and generally conform to the boundary of first build part 918.

FIG. 9B shows a build layer 936 for a second build part 938 where the heating pattern includes a boundary 922 and heating vectors 934.

FIG. 9C shows a build layer 956 for a third build part 958 where the heating pattern includes a boundary 942 and heating vectors 954.

FIG. 9D shows a build layer 976 for a multi-part build which includes a fourth build part 978A and a fifth build part 978B. Multi-part builds are used to beneficially save resources such as build material and energy. The heating pattern for fourth build part 978A includes a boundary 962A and heating vectors 974A. The heating pattern for fifth build part 978B includes a boundary 962B and heating vectors 974B. In this embodiment, build parts 978A and 978B are positioned on build layer 976 such that boundaries 962A and 962B partially overlap. Consequently, heating vectors 974A and 974B also overlap.

In some embodiments, the overlap of heating vectors 974A and 974B may be accounted for in the magnitudes of energy. In some embodiments, the directions and/or orientation of the heating vectors for each heating pattern may not be the same. In some embodiments, multi-part builds may include more than two parts.

The heating patterns described herein may represent a pre-heating pattern and/or a post-heating pattern. In some embodiments, a process for additively manufacturing a build part or object may include several stages for each solidified layer of build material. For example, the process may include a pre-heating stage for the build layer, a pre-heating stage localized to the build part, a melting stage, a post-heating stage localized to the build part, and/or a post-heating stage for the build layer. Each stage includes one of more heating or melting patterns. Thus, a build layer may include multiple pre-heating, melting, and post-heating patterns. In some examples, the magnitude of energy may be highest in the heating patterns for the build layer, lowest for the heating patterns localized to the build part, and somewhere in between for the melting patterns. Thus, the magnitude of energy required for the melting phase is less than at least part of the pre-heating phase. In some embodiments, the magnitude of energy has a transition rate when transitioning between heating or melting phases and/or patterns. In some embodiments, the magnitude of energy has a lower transition rate for the first pre-heating pattern than the other heating or melting patterns.

Though certain aspects are described herein discuss dividing the heating area into a set of strips of straight and parallel lines of equal strip width, the heating area could be divided into a set “strips” with different geometries such as curved, angled, etc. In some embodiments, the strip width may vary for one or more strips. In some embodiments, one or more strips may correspond to a plurality of heating vectors per each strip such that each heating vector in the plurality of heating vectors corresponds to a different path direction. In some embodiments, one of the plurality of heating vectors corresponds to one of the strips such that the one plurality of heating vectors corresponds to a complex path. The complex path may be based off a linear or non-linear function. For example, the complex path may be based off of one or more wave types such as sinusoidal, sawtooth, triangle, rectangular, etc.

### Example of Methods for Generating and Implementing Randomized Heating Patterns

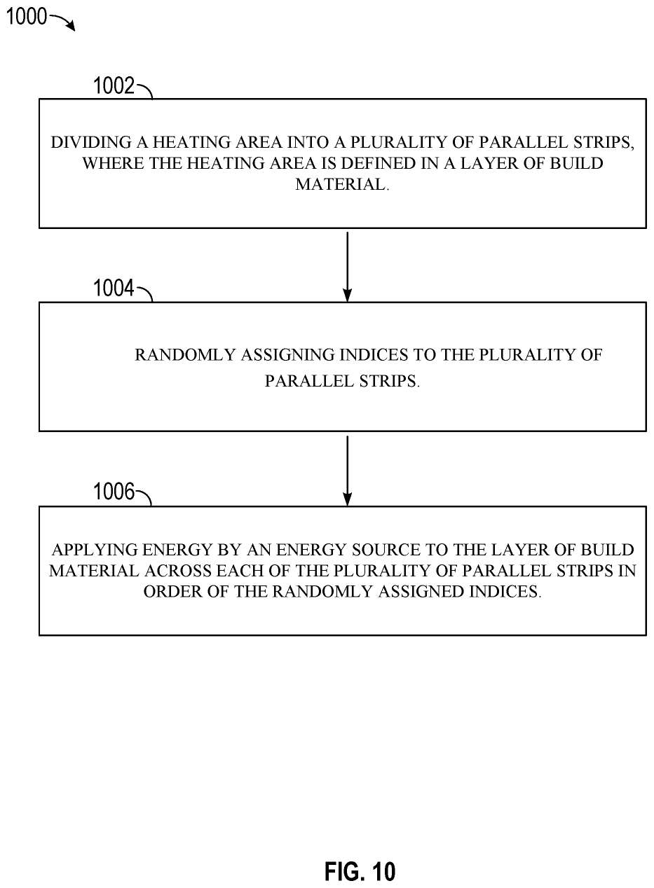

FIG. 10 depicts an example method 1000 for generating a randomized heating pattern. The method 1000 may be performed by a suitable computing device, such as a computer (e.g., computer 102a of FIG. 1).

Method 1000 begins at step 1002 with dividing a heating area into a plurality of parallel strips, where the heating area is defined in a layer of build material

Method 1000 then proceeds to step 1004 with randomly assigning indices to the plurality of parallel strips.

Method 1000 then proceeds to step 1006 with applying energy by an energy source to the layer of build material across each of the plurality of parallel strips in order of the randomly assigned indices.

In certain aspects, the energy source comprises an electron beam.

In certain aspects, the plurality of parallel strips are assigned a plurality of vectors based on the randomly assigned indices. In certain aspects, the plurality of vectors comprise a spatial position for the energy source to apply the energy to the layer of build material and a direction for the energy source to apply the energy to the build material. In certain aspects, the plurality of vectors comprise at least one magnitude of energy. In certain aspects, the plurality of vectors comprise at least one speed. In certain aspects, the direction for the energy source to apply the energy to the build material alternates with the order of the randomly assigned indices.

In certain aspects, applying the energy is performed prior to applying additional energy to one or more portions of the layer of build material using the energy source to melt the one or more portions of the layer of build material. In certain aspects, applying the energy is performed after applying additional energy to one or more portions of the layer of build material using the energy source to melt the one or more portions of the layer of build material.

In certain aspects, method 1000 further includes dividing a second heating area into a second plurality of parallel strips, where the second heating area is defined in the layer of build material. In certain aspects, method 1000 then proceeds to randomly assigning second indices to the second plurality of parallel strips. In certain aspects, method 1000 then proceeds to applying energy by the energy source to the layer of build material across each of the second plurality of parallel strips in order of the randomly assigned second indices.

In certain aspects, the heating area corresponds in shape to a first cross-section of a first object in the layer of build material, and wherein the second heating area corresponds in shape to a second cross-section of a second object in the layer of build material. In certain aspects, the heating area corresponds in size and shape to the entire layer of build material. In certain aspects, the heating area corresponds in size and shape to a cross-section of an object in the layer of build material. In certain aspects, the heating area corresponds in shape to the entire layer of build material. In certain aspects, the heating area corresponds in shape to a cross-section of an object in the layer of build material.

In certain aspects, method 1000 further includes dividing a second heating area into a second plurality of parallel strips, where the second heating area is defined in a second layer of build material, where the first layer of build material corresponds to a first slice of an object, and where the second layer of build material corresponds to a second slice of the object. In certain aspects, method 1000 then proceeds to randomly assigning second indices to the second plurality of parallel strips. In certain aspects, method 1000 further proceeds to applying energy by the energy source to the layer of build material across each of the second plurality of parallel strips in order of the randomly assigned second indices. In certain aspects, the second heating area and the first heating area have a same size and shape. In certain aspects, at least a portion of the second heating area overlaps at least a portion of the first heating area. In certain aspects, the second heating area occupies a different area of the layer of build material than the first heating area.

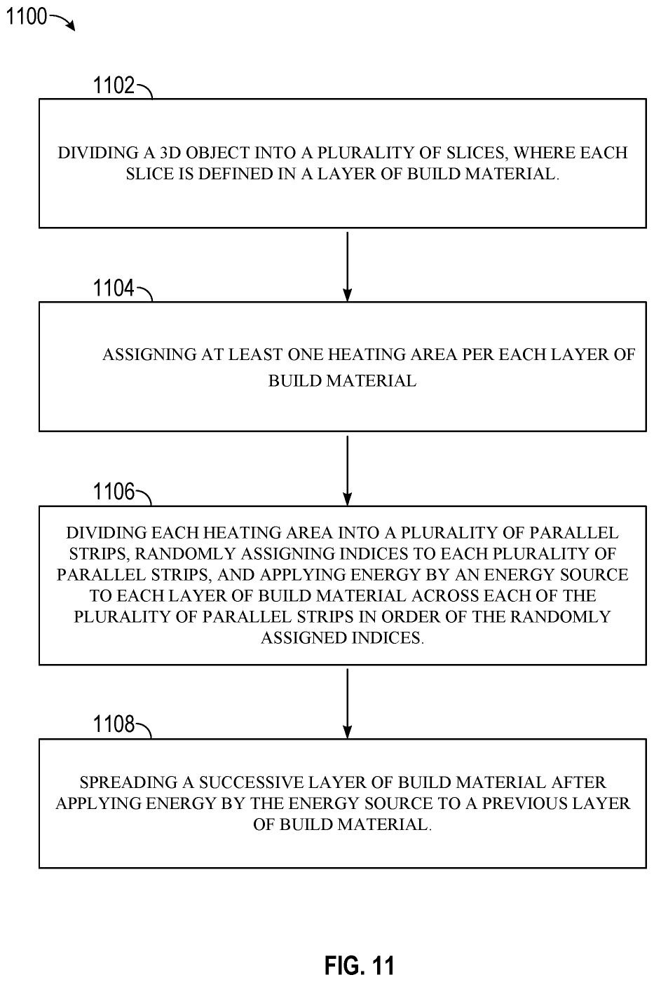

FIG. 11 depicts an example method 1100 for implementing a randomized heating pattern on an additive manufacturing apparatus. The method 1100 may be performed by a suitable computing device, such as a computer (e.g., computer 102a of FIG. 1), and a suitable additive manufacturing machine (e.g., additive manufacturing machine 106a or EBM machine 400 of FIG. 4A).

Method 1100 begins at step 1102 with dividing a 3D object into a plurality of slices, where each slice is defined in a layer of build material

Method 1100 then proceeds to step 1104 with assigning at least one heating area per each layer a build material.

Method 1100 then proceeds to step 1106 with dividing each heating area into a plurality of parallel strips, randomly assigning indices to each plurality of parallel strips, and applying energy by an energy source to each layer of build material across each of the plurality of parallel strips in order of the randomly assigned indices.

Method 1100 then proceeds to step 1108 with spreading a successive layer of build material after applying energy by the energy source to a previous layer of build material.

In certain aspects, the energy source comprises an electron beam.

In certain aspects, the plurality of parallel strips are assigned a plurality of vectors based on the randomly assigned indices. In certain aspects, the plurality of vectors comprise a spatial position for the energy source to apply the energy to the layer of build material and a direction for the energy source to apply the energy to the build material. In certain aspects, the plurality of vectors comprise at least one magnitude of energy. In certain aspects, the plurality of vectors comprise at least one speed. In certain aspects, the direction for the energy source to apply the energy to the build material alternates with the order of the randomly assigned indices.

In certain aspects, applying the energy is performed prior to applying additional energy to one or more portions of the layer of build material using the energy source to melt the one or more portions of the layer of build material. In certain aspects, applying the energy is performed after applying additional energy to one or more portions of the layer of build material using the energy source to melt the one or more portions of the layer of build material.

In certain aspects, the successive layer of build material is spread by a recoating mechanism. In certain aspects, the successive layer of build material is spread by a powder layering system.

In certain aspects, the successive layer of build material is spread after using the energy source to melt the one or more portions of the layer of build material. In certain aspects, the successive layer of build material is spread after applying the energy source to the one or more portions of the layer of build material.

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein include one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

Various embodiments disclosed herein provide for the use of a computer control system. A skilled artisan will readily appreciate that these embodiments may be implemented using numerous different types of computing devices, including both general purpose and/or special purpose computing system environments or configurations. Examples of well-known computing systems, environments, and/or configurations that may be suitable for use in connection with the embodiments set forth above may include, but are not limited to, personal computers, server computers, hand-held or laptop devices, multiprocessor systems, microprocessor-based systems, programmable consumer electronics, network PCs, minicomputers, mainframe computers, distributed computing environments (e.g., networks, cloud computing systems, etc.) that include any of the above systems or devices, and the like. These devices may include stored instructions, which, when executed by a microprocessor in the computing device, cause the computer device to perform specified actions to carry out the instructions. As used herein, instructions refer to computer-implemented steps for processing information in the system. Instructions can be implemented in software, firmware or hardware and include any type of programmed step undertaken by components of the system.

A microprocessor may be any conventional general purpose single- or multi-chip microprocessor such as a Pentium® processor, a Pentium® Pro processor, a 8051 processor, a MIPS® processor, a Power PC® processor, or an Alpha® processor. In addition, the microprocessor may be any conventional special purpose microprocessor such as a digital signal processor or a graphics processor. The microprocessor typically has conventional address lines, conventional data lines, and one or more conventional control lines.

Aspects and embodiments of the inventions disclosed herein may be implemented as a method, apparatus or article of manufacture using standard programming or engineering techniques to produce software, firmware, hardware, or any combination thereof. The term “article of manufacture” as used herein refers to code or logic implemented in hardware or non-transitory computer readable media such as optical storage devices, and volatile or non-volatile memory devices or transitory computer readable media such as signals, carrier waves, etc. Such hardware may include, but is not limited to, field programmable gate arrays (“FPGAs”), application-specific integrated circuits (“ASICs”), complex programmable logic devices (“CPLDs”), programmable logic arrays (“PLAs”), microprocessors, or other similar processing devices.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for heating during additive manufacturing, comprising:
dividing a heating area into a plurality of strips, the heating area defined in a layer of build material;
randomly assigning indices to the plurality of strips; and
applying energy by an energy source to the layer of build material across each of the plurality of strips in order of the randomly assigned indices.

2. The method of claim 1, wherein the plurality of strips comprise parallel strips.

3. The method of claim 1, wherein the energy source comprises an electron beam.

4. The method of claim 1, wherein the plurality of strips are assigned a plurality of vectors based on the randomly assigned indices, and wherein the plurality of vectors comprise a spatial position for the energy source to apply the energy to the layer of build material and a direction for the energy source to apply the energy to the build material.

5. The method of claim 4, wherein the plurality of vectors comprise at least one magnitude of energy.

6. The method of claim 4, wherein the plurality of vectors comprise at least one speed.

7. The method of claim 4, wherein the direction for the energy source to apply the energy to the build material alternates with the order of the randomly assigned indices.

8. The method of claim 1, wherein the applying the energy is performed prior to separately applying energy to one or more portions of the layer of build material using the energy source to melt the one or more portions of the layer of build material.

9. The method of claim 1, wherein the applying the energy is performed after separately applying energy to one or more portions of the layer of build material using the energy source to melt the one or more portions of the layer of build material.

10. The method of claim 1, further comprising:
dividing a second heating area into a second plurality of strips, the second heating area defined in the layer of build material;
randomly assigning second indices to the second plurality of strips; and
applying energy by the energy source to the layer of build material across each of the second plurality of strips in order of the randomly assigned second indices.

11. The method of claim 10, wherein the second plurality of strips comprises parallel strips.

12. The method of claim 10, wherein the heating area corresponds in shape to a first cross-section of a first object in the layer of build material, and wherein the second heating area corresponds in shape to a second cross-section of a second object in the layer of build material.

13. The method of claim 10, wherein at least a portion of the second heating area overlaps at least a portion of the heating area.

14. The method of claim 10, wherein the second heating area occupies a different area of the layer of build material than the heating area.

15. The method of claim 1, wherein the heating area corresponds in size and shape to the entire layer of build material.

16. The method of claim 1, wherein the heating area corresponds in size and shape to a cross-section of an object in the layer of build material.

17. The method of claim 1, wherein the heating area corresponds in shape to the entire layer of build material.

18. The method of claim 1, wherein the heating area corresponds in shape to a cross-section of an object in the layer of build material.

19. The method of claim 1, further comprising:
dividing a second heating area into a second plurality of strips, the second heating area defined in a second layer of build material, the layer of build material corresponding to a first slice of an object, and the second layer of build material corresponding to a second slice of the object;
randomly assigning second indices to the second plurality of strips; and
applying energy by the energy source to the layer of build material across each of the second plurality of strips in order of the randomly assigned second indices.

20. The method of claim 19, wherein the second plurality of strips comprises parallel strips.

21. The method of claim 19, wherein the second heating area and the heating area have a same size and shape.

22. A computing device comprising:
memory; and
one or more processors coupled to the memory, wherein the memory and the one or more processors are configured to cause the computing device to perform a method for heating during additive manufacturing, comprising:
dividing a heating area into a plurality of strips, the heating area defined in a layer of build material;
randomly assigning indices to the plurality of strips; and
causing an energy source to apply energy to the layer of build material across each of the plurality of strips in order of the randomly assigned indices.

23. A non-transitory computer-readable medium including instructions that when executed by an apparatus, cause the apparatus to perform a method for heating during additive manufacturing, comprising:
dividing a heating area into a plurality of strips, the heating area defined in a layer of build material;
randomly assigning indices to the plurality of strips; and
causing an energy source to apply energy to the layer of build material across each of the plurality of strips in order of the randomly assigned indices.
